(19) United States
(12) Patent Application Publication
(10) Pub. No.: US 2010/0129232 A1
(43) Pub. Date: May 27, 2010

(54) FLOAT DEVICE FOR A SEWAGE PUMP

(76) Inventor: Robert M. Keener, Ashland, OH (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/276,461

(22) Filed: Nov. 24, 2008

(51) Int. Cl. H01H 35/18; F04B 49/04

(52) U.S. Cl. 417/40; 200/84 R

(57) ABSTRACT

A float device for a sewage pump is a controlling switch to actuate or stop the sewage pump, wherein the sewage pump is mounted on a bottom inside a sewage tank to process waste. The float device floats along with the arising of liquid level in the sewage tank so that a magnet element inside attract with a corresponding metal part on the controlling switch. On the contrary, when the float device lowers along with the decreasing of liquid level, the magnet element disengages from the metal part to stop the sewage pump. By having float device operated by the magnetic way with few frictional wear, the switch has extended lifespan. Moreover, the float device is convenient in replacement when the float device is malfunctioned.

### BACKGROUND OF THE INVENTION

1. Field of the Invention

The present invention relates to a float device for a sewage pump, and more particularly to a float device served as a switch of the sewage pump attached to a bottom of a sewage tank to process waste so that the lifespan of the switch is extended and replacement of the switch is convenient.

2. Description of Related Art

One conventional sewage-processing device mounted on a bottom of a sewage tank is to actuate the sewage pump by a mechanical controlling switch to control the operation of the sewage and to inhale precipitation for grinding or smashing. With reference to a U.S. Pat. No. 6,140,925 published on Oct. 31, 2000 and a U.S. Pat. No. 5,155,311 published on Oct. 13, 1992, both patents refer another conventional sewage-processing device that has a switch that is is composed of at least two magnet elements attractive or repulsive with each other to achieve the control. However, this conventional switch often incurs malfunctions caused by frequent operations after certain duration. Repair of the conventional sewage processing is troublesome and time-consuming because the switch attached to the switch pump has to be suspended during repair by operator.

### SUMMARY OF THE INVENTION

A main objective of the present invention is to provide a float device that serves as a switch of a sewage pump.

To achieve the foregoing objective, the float device comprises:

a base electrically connecting to the sewage pump, mounted with a controlling circuit and having a recess with an opening defined in the base and having a metal part attached inside the recess;

a connecting rod with an abutting end penetrating the opening on the base and having a magnet element attached to the abutting end to operationally attract or disengage with the metal part on the base to achieve the actuation or stop of the sewage pump;

a top cap covering the base to enclose the controlling circuit; and

a floating body attached to a lower end of the connecting rod.

Further benefits and advantages of the present invention will become apparent after a careful reading of the detailed description with appropriate reference to the accompanying drawings.

### BRIEF DESCRIPTION OF THE DRAWINGS

FIG. 1 is an operational cross-sectional side view of a float device in accordance with the present invention, wherein the float device connects with a sewage pump;

FIG. 2 is an exploded perspective view of the float device in FIG. 1;

FIGS. 3A and 3B are enlarged cross-sectional operational views of the float device showing combination of a connecting rod and a controlling switch; and

FIG. 4 is a perspective view showing the combination of the float device and the sewage pump.

### DETAILED DESCRIPTION OF THE PREFERRED EMBODIMENT

A float device for a sewage pump is to serve as a switch of the sewage pump, wherein the sewage pump is mounted on a bottom inside sewage tank to process waste. The float device floats upward along with the arising of liquid level in the sewage tank so that a magnet element inside the float device attracts with a corresponding metal part on a controlling switch. On the contrary, when the float device lowers along with the decreasing of liquid level, the magnet element disengages from the metal part of the controlling switch by gravity to stop the sewage pump. By taking the float device as the switch, the switch has extended lifespan. Moreover, the float device is convenient in replacement when the float device is malfunctioned.

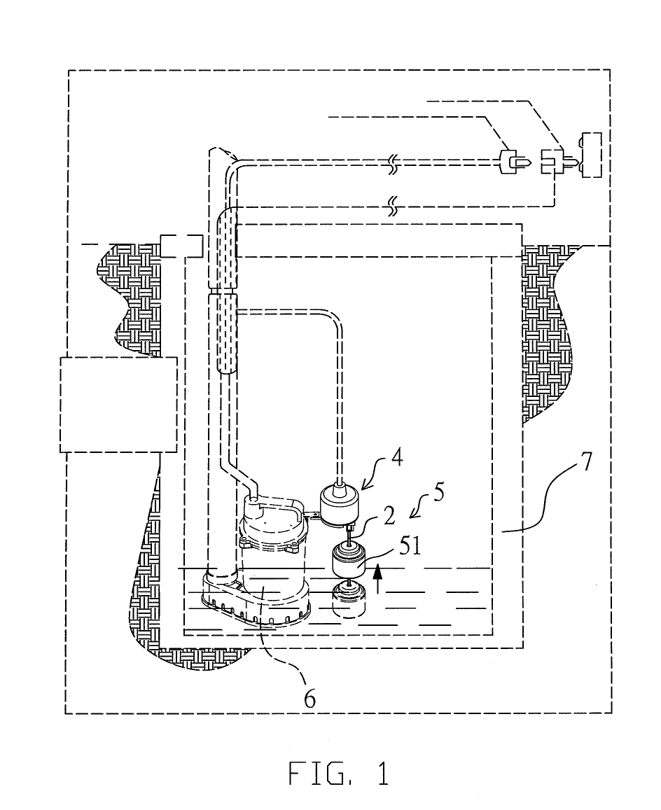

With reference to FIG. 1, a preferred embodiment of the float device is to serve as a switch for actuating or stopping to a sewage pump 6 mounted on a bottom of a sewage tank 7, wherein:

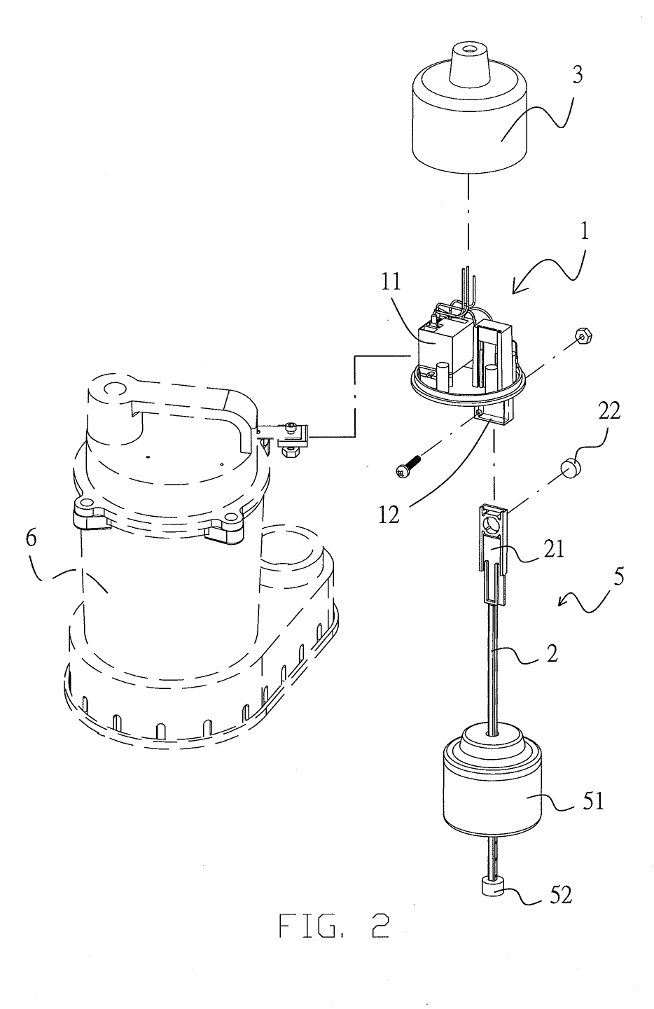

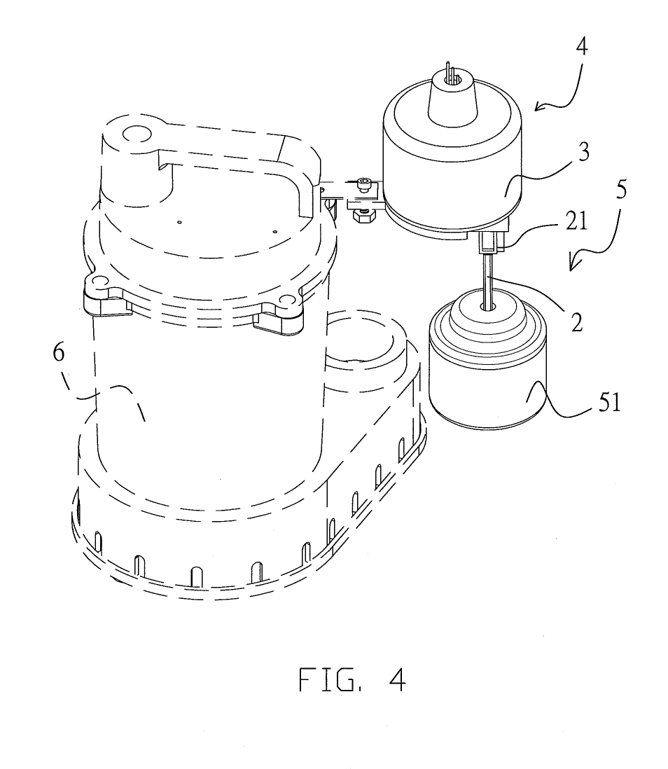

The sewage pump 6 is controlled to actuate or stop by a float device 5 for switching (as shown in FIG. 4). The float device 5 (as shown in FIG. 2) comprises a controlling switch 1 with controlling circuit 11 electrically connect to the sewage pump 6, a connecting rod 2 with a magnet element 22, a top cap 3 mounted on the controlling switch 1 to achieve the whole base 4.

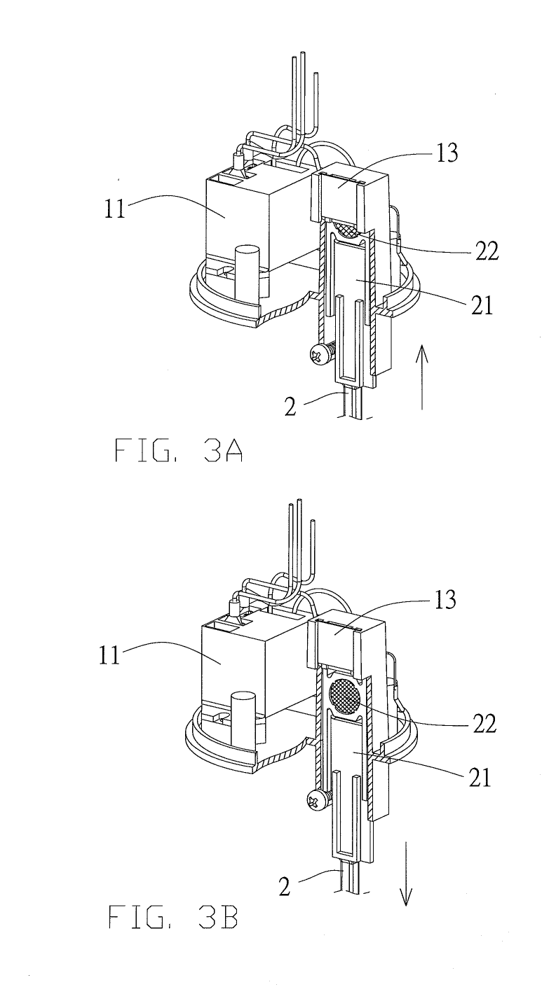

The controlling switch 1 is a round plate and has the controlling circuit 11 mounted thereon and a recess with an opening 12 defined on the plate opposite to allow an abutting head 21 having the magnet element 22 on one end of the connecting rod 2 to pass through (as shown in FIGS. 3A and 3B). A metal part 13 is attached inside the recess of the controlling switch 1 so that the magnet element 22 on the connecting rod 2 is operationally attractive to the metal part 13 on the controlling switch 1 to perform actuating to the sewage pump 6. Additionally, the controlling switch 1 is covered by the top cap 3 to achieve the base 4 (further reference to FIG. 4). The connecting rod 2 has its lower end sleeved by the floating body 51 with a stopper 52 (the stopper is made of rubber in this preferred embodiment) to limit the movement of the floating body 51.

When the float device 5 controls the actuation or stop of the sewage pump 6 (as shown in FIGS. 1, 3A and 3B), the floating body 51 moves along with the arising of the liquid level of the sewage in the sewage tank 7 to drive the connecting rod 2 move upward to make the magnet element 22 to attract with the corresponding metal part 13 on the controlling switch 1 to actuate the sewage pump 6. On the contrary, when the floating body 51 moves along with the lowering of the liquid level of the sewage in the sewage tank 7 to make the magnet element 22 on the connecting rod 2 to disengage from the metal part 13 by gravity on the controlling switch 1 to stop the sewage pump 6 but the connecting rod 2 is not separated from the controlling switch 1. By constructing the switch in form of float device as described above to provide a buffering efficiency and has no frictional wear because it is performed by a non-mechanical way, i.e. the magnet operation, the switch has an extended lifespan. Moreover, the floating body 51 is replaced conveniently when malfunctioned because the connecting rod 2 is combined by screw (not shown) and independently separable.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A float device for a sewage pump is a switch adapted to actuate or stop a sewage pump mounted inside a sewage tank, the float device comprising:
a base electrically connecting to the sewage pump, mounted with a controlling circuit and having a recess with an opening defined in the base and having a metal part attached inside the recess;
a connecting rod with an abutting end penetrating the opening on the base and having a magnet element attached to the abutting end to operationally attract or disengage with the metal part on the base to achieve the actuation or stop of the sewage pump;
a top cap covering the base to enclose the controlling circuit; and
a floating body attached to a lower end of the connecting rod.

2. The float device for a sewage pump as claimed in claim 1, wherein the float device further has a stopper attached to the connecting rod under the floating body.

3. The float device for a sewage pump as claimed in claim 2, wherein the stopper is made of rubber.
